(19) United States
(12) Patent Application Publication
(10) Pub. No.: US 2018/0012130 A1
(43) Pub. Date: Jan. 11, 2018

(54) SYSTEMS AND METHODS FOR FORECASTING TRENDS

(71) Applicant: Facebook, Inc., Menlo Park, CA (US)

(72) Inventors: Sean Jude Taylor, San Francisco, CA (US); Alexander Peysakhovich, San Francisco, CA (US); Ann Katharine Steele, San Francisco, CA (US); Andrew Garrod Bosworth, Palo Alto, CA (US)

(21) Appl. No.: 15/202,470

(22) Filed: Jul. 5, 2016

(51) Int. Cl. G06N 5/04; G06N 99/00

(52) U.S. Cl. CPC G06N 5/04; G06N 99/005

(57) ABSTRACT

Systems, methods, and non-transitory computer-readable media train a machine learning model to forecast growth of a content item, the growth being measured based at least in part on a count of user interactions with the content item, wherein the model is trained to adjust growth forecasts for the content item in response to one or more users interacting with the content item. A first growth forecast for the content item can be determined for a unit of time using the machine learning model. A determination is made that a first user has interacted with the content item. A second growth forecast for the content item can be determined for the unit of time using the machine learning model and based at least in part on the first user interacting with the content item.

### FIELD OF THE INVENTION

The present technology relates to the field of data forecasting. More particularly, the present technology relates to techniques for generating forecasting models for predicting growth.

### BACKGROUND

Today, people often utilize computing devices (or systems) for a wide variety of purposes. Users can use their computing devices to, for example, interact with one another, access content, share content, and create content. In some cases, content items can include postings from members of a social network. The postings may include text and media content items, such as images, videos, and audio. The postings may be published to the social network for consumption by others.

Under conventional approaches, a user can operate the computing device to build forecasting models for a time series data set, for example. A time series generally includes a sequence of data points consisting of successive measurements that are made over some period of time, such as the price of a stock that is measured daily over a year. Such forecasting models can be used to estimate, or predict, future values based on the previously observed values that are included in the time series data set.

### SUMMARY

Various embodiments of the present disclosure can include systems, methods, and non-transitory computer readable media configured to train a machine learning model to forecast growth of a content item, the growth being measured based at least in part on a count of user interactions with the content item, wherein the model is trained to adjust growth forecasts for the content item in response to one or more users interacting with the content item. A first growth forecast for the content item can be determined for a unit of time using the machine learning model. A determination is made that a first user has interacted with the content item. A second growth forecast for the content item can be determined for the unit of time using the machine learning model and based at least in part on the first user interacting with the content item.

In an embodiment, the content item corresponds to at least one of a page, post, media item, or link that is published through the computing system.

In an embodiment, the user interaction corresponds to at least one of a selection of a like option, a selection of a check-in option, posting content, or sharing content.

In an embodiment, the machine learning model is trained using user interactions that are measured for a group of users of a particular demographic, and wherein the machine learning model predicts growth of the content item based on interactions from users in the particular demographic.

In an embodiment, the systems, methods, and non-transitory computer readable media are configured to generate a set of training examples that each correspond to a unit of time and include an outcome, a position value determined for the unit of time, a velocity value determined for the unit of time, an acceleration value determined for the unit of time, and respective values indicating which users interacted with the content item during the unit of time.

In an embodiment, the systems, methods, and non-transitory computer readable media are configured to generate a growth curve for the content item, the growth curve plotting a growth of the content item for each unit of time over a period of time, determine the position value for the unit of time based at least in part on the growth curve, determine the velocity value for the unit of time based at least in part on the growth curve, and determine the acceleration value for the unit of time based at least in part on the growth curve.

In an embodiment, the systems, methods, and non-transitory computer readable media are configured to provide a set of input values that include values describing a shape of a growth curve for the content item at a preceding unit of time and respective values indicating which users have interacted with the content item by the preceding the unit of time, wherein the respective value for the first user indicates that the first user has not interacted with the content item.

In an embodiment, the systems, methods, and non-transitory computer readable media are configured to provide a set of input values that include values describing a shape of a growth curve for the content item at a preceding unit of time and respective values indicating which users have interacted with the content item at the preceding the unit of time, wherein the respective value for the first user indicates that the first user has interacted with the content item.

In an embodiment, the second growth forecast is adjusted in response to the first user having interacted with the content item.

In an embodiment, the machine learning model is trained to adjust the second growth forecast based at least in part on a step function, linear growth function, or a growth curve function.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example modeling module, according to an embodiment of the present disclosure.

FIG. 2 illustrates an example growth modeling module, according to an embodiment of the present disclosure

FIG. 3 illustrates an example model training module, according to an embodiment of the present disclosure.

FIG. 4 illustrates an example visual graph, according to an embodiment of the present disclosure.

FIG. 5 illustrates an example method for generating a growth model, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Forecasting Trends

People often utilize computing devices (or systems) for a wide variety of purposes. Users can use their computing devices to, for example, interact with one another, access content, share content, and create content. In some cases, content items can include postings from users of a social networking system. The postings may include text and media content items, such as images, videos, and audio. The postings may be published to the social network for consumption by others.

Users of the social networking system may interact with other users and/or posts that were published through the social networking system. Such interactions may involve selecting options, such as a “like” option for endorsing various content published through the social networking system (e.g., a post, a link, an image, etc.), posting comments on the various content, sharing the various content, and/or simply accessing the various content for some measurable period of time, to name some examples. In some instances, various pages may be provided through the social networking system and each page may correspond to some entity (e.g., a celebrity, music band, restaurant, point of interest, etc.). Users of the social networking system can interact with such pages, for example, by selecting a “like” option to endorse a page, selecting a “check-in” option to check-in at a geographic location associated with a page, sharing content with other users through a page, and posting messages through a page, to name some examples.

Such user interactions can be used to measure the growth of a page over time. In some instances, the growth of a page can suggest that an entity associated with the page is trending (e.g., becoming popular). For example, if enough users increasingly “like” a page that is associated with a musician, then this increase can indicate that the musician is becoming popular among the users. In some instances, a model can be trained to predict the future growth of a page based on historical data that measures user interactions with pages (e.g., likes) over some preceding period of time. For example, a model may be trained using a time series that indicates the number of likes that were received each day for a page over some period of time. While this model can be used to predict the number of likes that are expected for the page on a future date, such forecasting does not account for changes in the page's growth (e.g., the number of likes that may be received in the future) that can result when certain influential users “like” the page. In one example, an influential user may be a user that has historically demonstrated to positively contribute to page growth. Thus, for example, the number of likes received for a page tend to increase by some margin after an influential user likes the page. As a result, growth forecasts produced by existing approaches tend to be less accurate since such approaches do not account for the contributions made by influential users. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In general, a computing system (or device) can be configured to train a model for predicting the growth of a page in a social networking system. Page growth may be measured using various types of user interactions such as likes, shares, check-ins, posting messages, to name some examples. For example, the model can be trained to predict the number of likes a page will have received at some future date. The model can be trained using data describing the growth of the page over each unit of time (e.g., day) for some period of time (e.g., 30 days). The data describing the growth of the page for a given day may include a position value (e.g., the number of likes received for the page by the given day), velocity value (e.g., the growth in the number of likes over some preceding period of time), and/or an acceleration value (e.g., the change in the growth over some preceding period of time). For example, on the given day, the page may have received 50,000 likes (position), 10,000 of those likes were received over the last 30 days (velocity), and 1,000 likes were received in the last 7 days (acceleration). In some embodiments, a model trained using the position, velocity, and/or acceleration values can predict a baseline growth of the page for some day in the future. To train the model to predict future growth based on users liking the page, in various embodiments, the model is also trained using feature values that indicate when users liked the page. In such embodiments, the model can be trained using data describing the growth of the page each day over some period of time and, for each day, indicating which users liked the page on that day. Such an approach allows for identifying and utilizing users (influential or non-influential) that provide meaningful signals to adjust the growth predictions for pages.

While the examples used herein describe the training of models to predict page growth based on user likes, the approaches described herein can be adapted to predict growth using any type of user interactions including, for example, predicting the number of posts that will be published through a page, predicting the number of user check-ins initiated through a page, and predicting the number of content items being shared through a page, to name some examples. Naturally, the approaches described herein are not limited to predicting the growth of pages and, in various embodiments, models can be trained to predict growth for other types of content items that permit user interaction such as groups, published posts, publishes media, to name some examples.

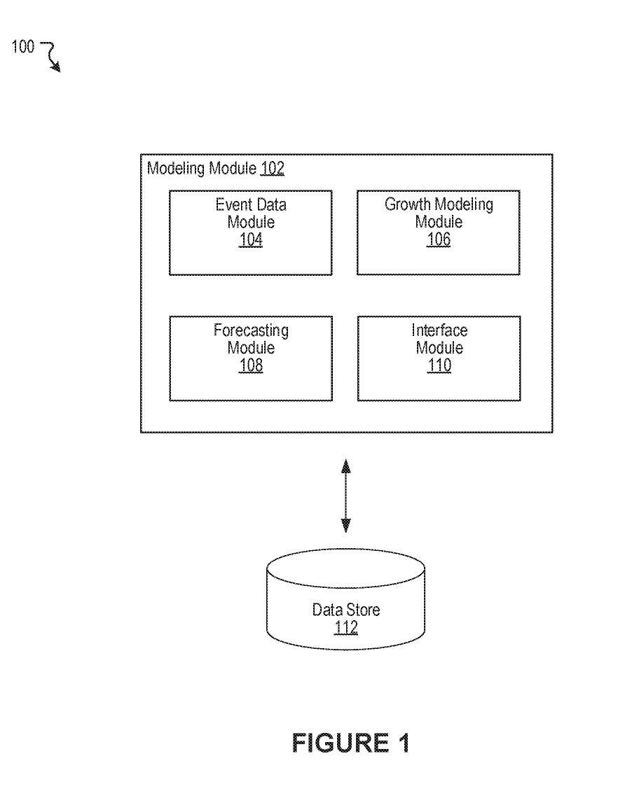

FIG. 1 illustrates an example system 100 including an example modeling module 102, according to an embodiment of the present disclosure. As shown in the example of FIG. 1, the modeling module 102 can include an event data module 104, a growth modeling module 106, a forecasting module 108, and an interface module 110. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

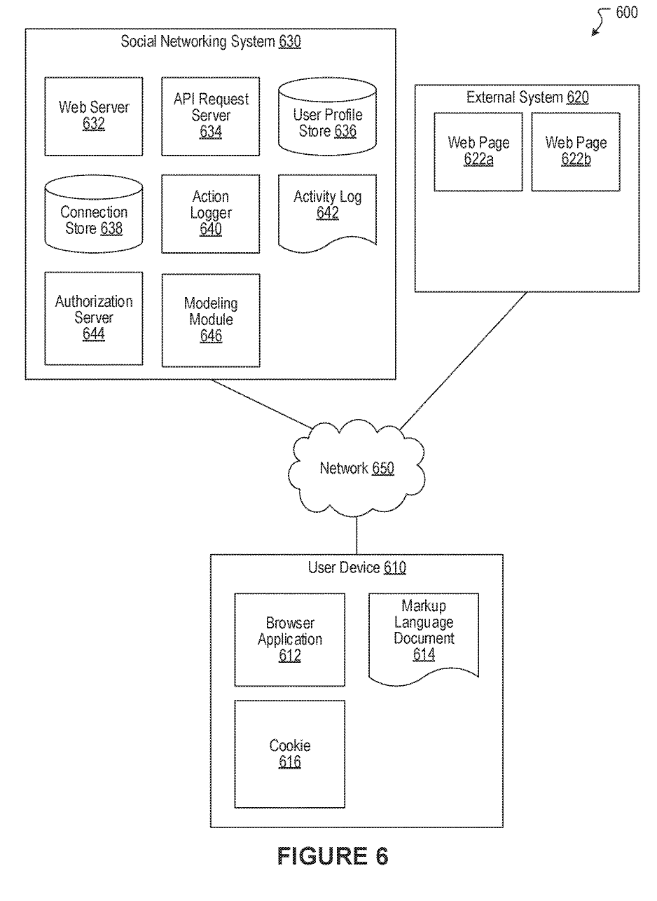

In some embodiments, the modeling module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the modeling module 102 can be implemented, in part or in whole, as software running on one or more computing devices or systems, such as on a user- or client computing device. For example, the modeling module 102, or at least a portion thereof, can be implemented as or within an application (e.g., app), a program, or an applet, etc., running on a user computing device or a client computing system, such as the user device 610 of FIG. 6. In another example, the modeling module 102, or at least a portion thereof, can be implemented using one or more computing devices or systems that include one or more servers, such as network servers or cloud servers. In some instances, the modeling module 102 can, in part or in whole, be implemented within or configured to operate in conjunction with a social networking system (or service), such as the social networking system 630 of FIG. 6. It should be understood that there can be many variations or other possibilities.

In some embodiments, the event data module 104 can be configured to obtain data sets (e.g., time series data sets) that describe various types of user interactions in the social networking system. The data sets can be provided in any structured or non-structured format. Typically, each data set can include a series of observations over a period of time. For each observation, the data set can identify a user, a respective unit, or content item, (e.g., page) with which the user interacted, and a timestamp of when the interaction occurred. For example, the event data module 104 can obtain a data set that describes which users liked a set of pages over a specified period of time. The event data module 104 can obtain such data sets across different dimensions. For example, a data set can include observations for a particular type of interaction (e.g., like, check-in, share, etc.), a particular set of users (e.g., users corresponding to a particular demographic), a particular set of units (e.g., pages that correspond to a particular category), and/or a particular time period (e.g., the last 60 days).

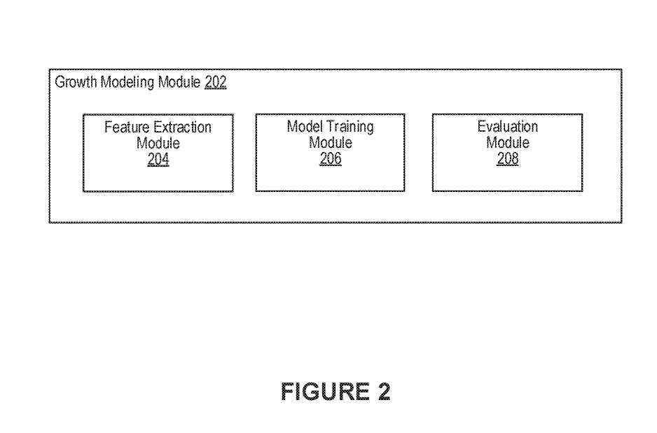

The growth modeling module 106 can be configured to generate growth models. For example, the growth modeling module 106 can generate a growth model for a given page and can also learn how such growth will be affected when various users interact with the page. More details regarding the growth modeling module 106 will be provided below in reference to FIG. 2.

The forecasting module 108 can be configured to predict growth forecasts for various pages based on models that are trained using the growth modeling module 106. As mentioned, a model can be trained to predict page growth at some future date. In one example, a model can be trained to predict the number of likes a page will receive at some future date (e.g., one or more days in the future). For example, a model that is trained to predict the number of likes the page will have received 7 days ahead of a current day can be provided a set of input values corresponding to the current day. In response, the model can output a predicted number of likes 7 days ahead based on the input values. The input values used can include the position, the velocity, and/or the acceleration values that correspond to the current day as well as data indicating which users liked the page on the current day.

The interface module 110 can be configured to provide an interface for requesting and accessing growth models. The interface can be any type of interface including, for example, a web-based interface, a command line interface, an application programming interface (API), to name some examples. Users can interact with the modeling module 102 through the interface, for example, to provide event data sets, access and/or modify generated growth models, access visual representations of growth forecasts, as well as to request, or generate, new growth forecasts. In various embodiments, data describing a generated growth model can be downloaded through the interface module 110, for example, in the form of a file. The downloaded growth model can then be implemented on a computing system and the computing system can utilize the growth model to perform the various operations described in this disclosure. For example, the computing system on which the growth model is implemented can be used to make forecasts using the growth model.

FIG. 2 illustrates an example growth modeling module 202 configured to generate growth models (e.g., regression models), according to an embodiment of the present disclosure. In some embodiments, the growth modeling module 106 of FIG. 1 can be implemented with the growth modeling module 202. As shown in the example of FIG. 2, the growth modeling module 202 can include a feature extraction module 204, a model training module 206, and an evaluation module 208.

The feature extraction module 204 can be configured to process event data sets that are obtained, for example, by the event data module 104 of FIG. 1, for which growth models are to be generated. The feature extraction module 204 can extract any features that are present in an event data set using generally known feature extraction techniques. In some embodiments, the feature extraction module 204 parses the event data to determine values that describe user interactions for some specified period of time (e.g., a 30-day time period). For example, the event data may indicate that a User A liked a page of a Musician B on Jan. 3, 2016. In this example, the feature extraction module 204 can determine the user, item, and time corresponding to the captured event, e.g., [User A, Musician B, Jan. 3, 2016]. In some instances, the event data may describe different types of user interactions. For example, the event data may indicate that a User A liked a page of a Musician B on Jan. 3, 2016 and the User A checked-in at a restaurant R on Jan. 4, 2016. In this example, the feature extraction module 204 can determine the user, item, interaction, and time corresponding to the captured event, e.g., [User A, Musician B, like, Jan. 3, 2016] and [User A, Restaurant R, check-in, Jan. 4, 2016].

In some embodiments, the feature extraction module 204 also generates growth, or adoption, curves using event data. In some embodiments, a growth curve for a page may be generated by aggregating event data for specified units of time (e.g., second, minute, hour, day, week, month, quarter, year, or any other customizable time period) over some period of time. For example, the feature extraction module 204 can produce a growth curve for the page by aggregating the number of users that liked the page each day over some period of time. In some embodiments, the feature extraction module 204 determines, for each unit of time, respective values that describe the shape of the growth curve at that unit of time. Such values can include, for a given unit of time, a corresponding position value, a velocity value, and/or an acceleration value.

In some embodiments, the position can describe the number of user interactions that occurred over the unit of time. For example, a growth curve for a page may indicate that the page received 300 likes on day 0 and 400 likes on day 1. In this example, the position value for day 0 is 300 while the position value for day 1 is 400. In some embodiments, the feature extraction module 204 computes velocity values for the units of time. For example, the velocity value for a day can be measured based on a change in the number of likes over some preceding period of time (e.g., the last 30 days). In some embodiments, the feature extraction module 204 computes acceleration values for the units of time. For example, the acceleration value for a day can be measured based on determining a change in the velocity value for the day (e.g., change in the number of likes received for a page over some preceding period of time). In one example, a model trained to account for such values can be used to predict the growth rate of a page based on the number of likes the page has so far received, e.g., 5,000 likes (position), the growth in the number of likes over some preceding period of time, e.g., 1,000 likes over the last month (velocity), and the change in the growth, e.g., page has received 100 likes in the last week (acceleration). Depending on the implementation, one, all, or any combination of the position, velocity, and acceleration values can be used to train the model.

In some embodiments, the feature extraction module 204 can generate a design matrix that describes the features that were extracted from event data. For example, each row in the design matrix can correspond to a specific unit of time (e.g., day) over some duration of time (e.g., 60 days). In one example, the columns in the design matrix can correspond to an outcome (e.g., the observed growth of a page at a future date), a position value, a velocity value, an acceleration value, and a separate column for each user being observed. Thus, for example, a row describing user interactions with a page on day 1 can indicate an outcome (e.g., the number of likes a page had received n days from day 1), the position value determined for day 1, the velocity value determined for day 1, the acceleration value determined for day 1, and which users liked the page on day 1. The observations included in the design matrix may correspond to one or more different pages. This data allows the model to learn corresponding weights for users and each weight can measure how influential a user was to the growth of the page. The users included in the design matrix for purposes of training the model can include all, or some segment of, users of the social networking system. For example, in some embodiments, the users may be restricted to users of a particular demographic (e.g., gender, age group, interest group, etc.) to determine how users in that demographic affect page growth. In some embodiments, the users may be restricted to users that have demonstrated a threshold amount of user activity, for example, as measured based on their interactions in the social networking system. In general, a user that positively contributes to page growth will have a positive weight while users that negatively contribute to page growth will have a negative weight. Users that are determined to not affect page growth can be assigned a weight of zero. The design matrix can be a data structure, such as a two-dimensional or three-dimensional matrix. In some embodiments, the design matrix can be used to generate the training data to be used for training a growth model.

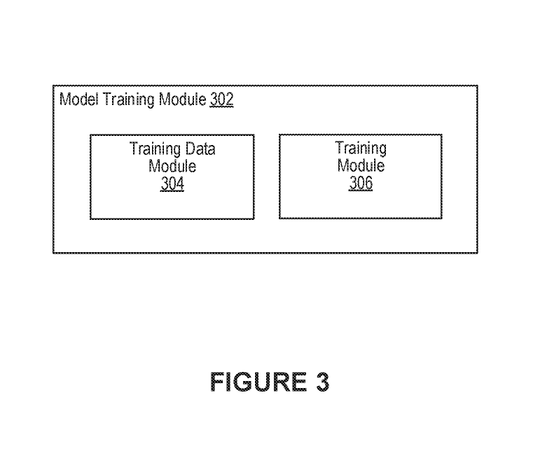

The model training module 206 can be configured to train a model for predicting page growth. More details regarding the model training module 206 will be provided below in reference to FIG. 3.

The evaluation module 208 can be configured to measure the predictive performance of a trained model. For example, in some embodiments, a portion of entries in the design matrix can be reserved for testing purposes. In one example, if the design matrix included a set of daily observations over a 60 day period, then the observations corresponding to the first 30 days can be used for training the model and the observations corresponding to the last 30 days can be used for evaluating the model's accuracy.

FIG. 3 illustrates an example model training module 302 configured to generate growth models (e.g., regression models), according to an embodiment of the present disclosure. In some embodiments, the model training module 206 of FIG. 2 can be implemented with the model training module 302. As shown in the example of FIG. 3, the model training module 302 can include a training data module 304 and a training module 306.

In various embodiments, the training data module 304 is configured to generate training data, for example, to be used for determining the future growth of a page (or some other specified content item). As mentioned, in some embodiments, page growth can be predicted for some future date using a trained machine learning model. For example, the model can be trained to predict the number of likes a page will have received on some future date in view of certain users liking the page. Such an approach allows the model to adjust the growth prediction to account for any increase and/or decrease in the number of likes that are expected for the page in response to certain users (influential or otherwise) liking the page. In some embodiments, such adjustments are made based on a step function. For example, if an influential user likes a page, then the growth forecast can be shifted upwards by some defined amount. Such adjustments can also be based on linear growth (e.g., growth forecast increases at a faster rate when an influential user likes the page) or curves with n parameters.

The training data used to train the machine learning model can include a number of training examples. In some embodiments, the training data corresponds to a set of observations for each unit of time (e.g., day) over some period of time (e.g., 120 days). In such embodiments, each training example can correspond to a day in the period of time and can include an outcome (e.g., the number of observed likes for a page n days from the day), the position value determined for the day, the velocity value determined for the day, the acceleration value determined for the day, and which users liked the page on the day. One example representation of a training example is as follows:

[Oⱼ, Pₜ, Vₜ, Aₜ, uₜ¹, . . . , uₜⁿ],

where Oⱼ corresponds to a number of likes being forecasted for a page on some day j in the future, where Pₜ corresponds to a position value determined for a day t using a growth curve corresponding to the page, where Vₜ corresponds to a velocity value determined for the day t, where Aₜ corresponds to an acceleration value determined for the day t, where uₜ¹ indicates whether a user 1 liked the page on day t, and where uₜⁿ indicates whether a user n liked the page on day t. Other features can be included in the training examples depending on the implementation. For example, in some embodiments, each training example can include a feature indicating a page identifier, category, and/or age of the page (e.g., days since the page was created).

The training module 306 can use these training examples to train the machine learning model. In general, any type of machine learning model may be used. In one example, the machine learning model is trained using a regularized regression technique. Once trained, the machine learning model will learn corresponding weights for users as well as respective coefficients for the position, velocity, and acceleration values. The trained model can then be used to forecast growth for the page, as described above.

In some embodiments, a model can be trained to predict growth in view of multiple types of user interactions. For example, the model can be trained to predict growth based on users liking a page and on users posting messages through the page. In this example, the model will learn multiple weights for each user (e.g., a first weight indicating a predictive weight of the user's likes and a second weight indicating a predictive weight of the user's posts). In some embodiments, a model can be trained to predict growth for sub-populations (e.g., demographic groups, special interest-based groups, etc.). In such embodiments, the model can be trained as described above along with additional features that describe the sub-populations. As a result, multiple weightings can be learned for each user and each weighting can indicate how predictive the user is for a given sub-population or group. In some embodiments, a model can be trained to predict growth for users that are similar to one another or have some association (e.g., friends). In such embodiments, the model can be used to predict growth based on users that provide a predictive signal for one or more sub-groups (e.g., friends). In some embodiments, a model can be trained, as described above, to predict a popularity for a point of interest (e.g., restaurant). In such embodiments, the model can be trained based on event data that describes user interactions (e.g., user check-ins, user posts mentioning the point of interest, etc.) with a content item (e.g., page) associated with the point of interest.

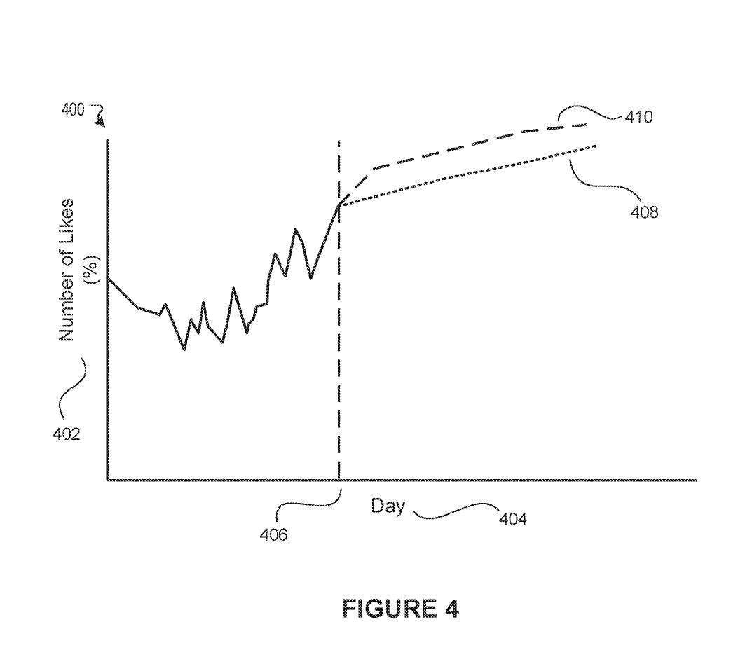

FIG. 4 illustrates an example visual graph 400, according to an embodiment of the present disclosure. In various embodiments, the visual graph 400 plots actions 402 by users over time 404. The actions 402 being measured and predicted can vary depending on the implementation as described above. Similarly, the user actions may be plotted over time 404 based on some specified unit of time (e.g., hourly, daily, weekly, monthly, etc.).

In the example of FIG. 4, the plotted user actions represent the number of likes 402 that were received for a page on a per day basis 404. In this example, an influential user liked the page on a day 406. In various embodiments, a model can be trained to predict the future growth of the page in view of actions taken (e.g., likes) by certain users (e.g., influential, or positively weighted, users), as described above. To distinguish this model from a conventional forecasting model, the visual graph 400 plots the number of likes 408 that were predicted for the page using a conventional forecasting model that does not adjust growth predictions in view of user actions. As a result, the conventional model bases future growth based on historical page likes. In contrast, the visual graph 400 also plots the number of likes 410 that are predicted for the page using the model that has been trained to adjust growth predictions in view of user actions, as described above. As shown, the growth predictions 410 by this model are adjusted in response to the influential user liking the page on day 406.

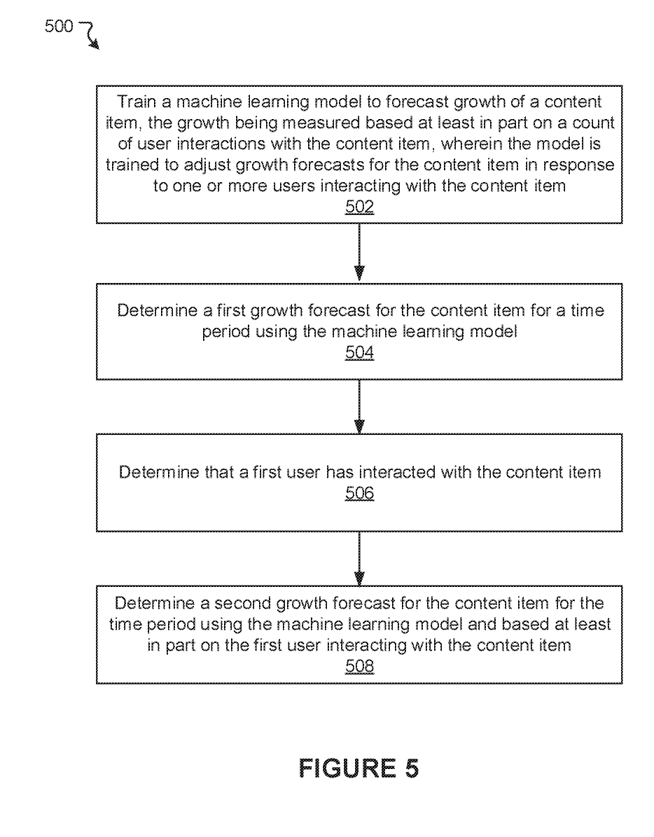

FIG. 5 illustrates an example method 500 for generating a growth model, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can train a machine learning model to forecast growth of a content item. The growth being measured based at least in part on a count of user interactions with the content item. The model is trained to adjust growth forecasts for the content item in response to one or more users interacting with the content item. At block 504, a first growth forecast for the content item can be determined for a unit of time using the machine learning model. At block 506, a determination is made that a first user has interacted with the content item. At block 508, a second growth forecast for the content item can be determined for the unit of time using the machine learning model and based at least in part on the first user interacting with the content item.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a modeling module 646. The modeling module 646 can, for example, be implemented as the modeling module 102 of FIG. 1. As discussed previously, it should be appreciated that there can be many variations or other possibilities.

### Hardware Implementation

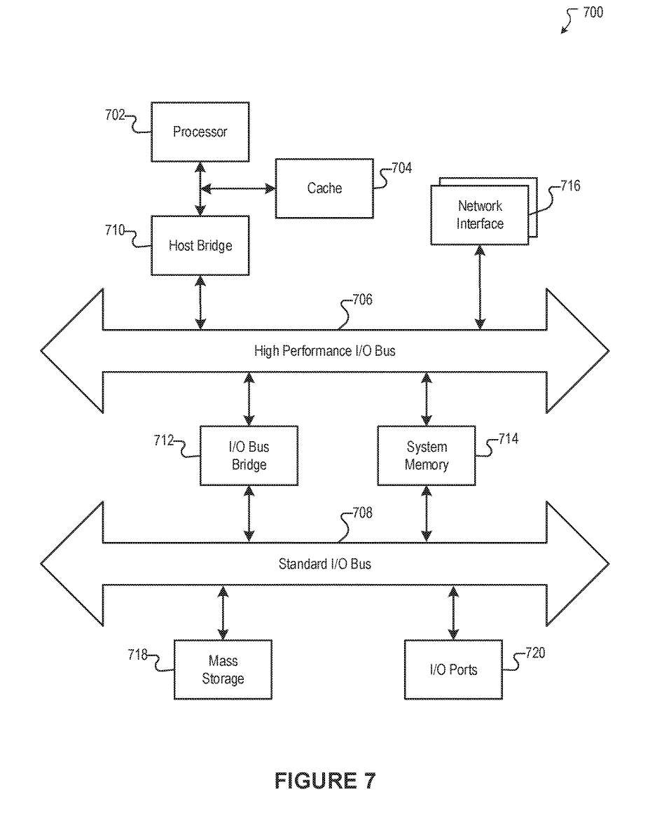

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
training, by a computing system, a machine learning model to forecast growth of a content item, the growth being measured based at least in part on a count of user interactions with the content item, wherein the model is trained to adjust growth forecasts for the content item in response to one or more users interacting with the content item;
determining, by the computing system, a first growth forecast for the content item for a unit of time using the machine learning model;
determining, by the computing system, that a first user has interacted with the content item; and
determining, by the computing system, a second growth forecast for the content item for the unit of time using the machine learning model and based at least in part on the first user interacting with the content item.

2. The computer-implemented method of claim 1, wherein the content item corresponds to at least one of a page, post, media item, or link that is published through the computing system.

3. The computer-implemented method of claim 1, wherein the user interaction corresponds to at least one of a selection of a like option, a selection of a check-in option, posting content, or sharing content.

4. The computer-implemented method of claim 1, wherein the machine learning model is trained using user interactions that are measured for a group of users of a particular demographic, and wherein the machine learning model predicts growth of the content item based on interactions from users in the particular demographic.

5. The computer-implemented method of claim 1, wherein training the machine learning model further comprises:
generating, by the computing system, a set of training examples that each correspond to a unit of time and include an outcome, a position value determined for the unit of time, a velocity value determined for the unit of time, an acceleration value determined for the unit of time, and respective values indicating which users interacted with the content item during the unit of time.

6. The computer-implemented method of claim 5, wherein generating the set of training examples further comprises:
generating, by the computing system, a growth curve for the content item, the growth curve plotting a growth of the content item for each unit of time over a period of time;
determining, by the computing system, the position value for the unit of time based at least in part on the growth curve;
determining, by the computing system, the velocity value for the unit of time based at least in part on the growth curve; and
determining, by the computing system, the acceleration value for the unit of time based at least in part on the growth curve.

7. The computer-implemented method of claim 1, wherein determining the first growth forecast for the content item for the unit of time further comprises:
providing, by the computing system, a set of input values that include values describing a shape of a growth curve for the content item at a preceding unit of time and respective values indicating which users have interacted with the content item by the preceding the unit of time, wherein the respective value for the first user indicates that the first user has not interacted with the content item.

8. The computer-implemented method of claim 1, wherein determining the second growth forecast for the content item for the unit of time further comprises:
providing, by the computing system, a set of input values that include values describing a shape of a growth curve for the content item at a preceding unit of time and respective values indicating which users have interacted with the content item at the preceding the unit of time, wherein the respective value for the first user indicates that the first user has interacted with the content item.

9. The computer-implemented method of claim 1, wherein the second growth forecast is adjusted in response to the first user having interacted with the content item.

10. The computer-implemented method of claim 10, wherein the machine learning model is trained to adjust the second growth forecast based at least in part on a step function, linear growth function, or a growth curve function.

11. A system comprising:
at least one processor; and
a memory storing instructions that, when executed by the at least one processor, cause the system to perform:
training a machine learning model to forecast growth of a content item, the growth being measured based at least in part on a count of user interactions with the content item, wherein the model is trained to adjust growth forecasts for the content item in response to one or more users interacting with the content item;
determining a first growth forecast for the content item for a unit of time using the machine learning model;
determining that a first user has interacted with the content item; and
determining a second growth forecast for the content item for the unit of time using the machine learning model and based at least in part on the first user interacting with the content item.

12. The system of claim 11, wherein the content item corresponds to at least one of a page, post, media item, or link that is published through the computing system.

13. The system of claim 11, wherein the user interaction corresponds to at least one of a selection of a like option, a selection of a check-in option, posting content, or sharing content.

14. The system of claim 11, wherein the machine learning model is trained using user interactions that are measured for a group of users of a particular demographic, and wherein the machine learning model predicts growth of the content item based on interactions from users in the particular demographic.

15. The system of claim 11, wherein training the machine learning model further causes the system to perform:
generating a set of training examples that each correspond to a unit of time and include an outcome, a position value determined for the unit of time, a velocity value determined for the unit of time, an acceleration value determined for the unit of time, and respective values indicating which users interacted with the content item during the unit of time.

16. A non-transitory computer-readable storage medium including instructions that, when executed by at least one processor of a computing system, cause the computing system to perform a method comprising:
training a machine learning model to forecast growth of a content item, the growth being measured based at least in part on a count of user interactions with the content item, wherein the model is trained to adjust growth forecasts for the content item in response to one or more users interacting with the content item;
determining a first growth forecast for the content item for a unit of time using the machine learning model;
determining that a first user has interacted with the content item; and
determining a second growth forecast for the content item for the unit of time using the machine learning model and based at least in part on the first user interacting with the content item.

17. The non-transitory computer-readable storage medium of claim 16, wherein the content item corresponds to at least one of a page, post, media item, or link that is published through the computing system.

18. The non-transitory computer-readable storage medium of claim 16, wherein the user interaction corresponds to at least one of a selection of a like option, a selection of a check-in option, posting content, or sharing content.

19. The non-transitory computer-readable storage medium of claim 16, wherein the machine learning model is trained using user interactions that are measured for a group of users of a particular demographic, and wherein the machine learning model predicts growth of the content item based on interactions from users in the particular demographic.

20. The non-transitory computer-readable storage medium of claim 16, wherein training the machine learning model further causes the computing system to perform:
generating a set of training examples that each correspond to a unit of time and include an outcome, a position value determined for the unit of time, a velocity value determined for the unit of time, an acceleration value determined for the unit of time, and respective values indicating which users interacted with the content item during the unit of time.
